(19) United States
(12) Patent Application Publication
(10) Pub. No.: US 2011/0069088 A1
(43) Pub. Date: Mar. 24, 2011

(54) SOURCE DRIVER AND CHARGE SHARING FUNCTION CONTROLLING METHOD THEREOF

(75) Inventors: Meng-Tse Weng, Tainan County (TW); Ying-Lieh Chen, Tainan County (TW); Chien-Ru Chen, Tainan County (TW); Chuan-Che Lee, Tainan County (TW)

(73) Assignee: HIMAX TECHNOLOGIES LIMITED, Tainan County (TW)

(21) Appl. No.: 12/563,354

(22) Filed: Sep. 21, 2009

(51) Int. Cl. G06F 3/038; G09G 5/10

(52) U.S. Cl. 345/690; 345/213

(57) ABSTRACT

A source driver includes a driver unit and a data analysis unit. The driver unit drives a display panel according to a video signal. The data analysis unit, which is coupled to the driver unit, analyzes gray level distribution of the video signal, and the data analysis unit enables or disables a charge sharing function of the driver unit according to an analysis result. As a result, the charge sharing function is enabled optionally during different charge sharing periods, and thus the power consumption in the source driver and the operation temperature of the source driver could be reduced as compared with the prior art.

### BACKGROUND OF THE INVENTION

1. Field of the Invention

The invention relates to a source driver. More particularly, the invention relates to a source driver for controlling a charge sharing function in a thereof.

2. Description of Related Art

Flat panel display apparatus, e.g. thin film transistor-liquid crystal display (TFT-LCD), has been proposed to serve as a replacement of a conventional cathode ray tube (CRT) display apparatus. As compared with the conventional CRT display, the TFT-LCD apparatus has advantages such as having relatively low voltage action, low power consumption, thin and small size, and light weight.

FIG. 1A shows a conventional LCD 100. The display 100 includes a timing controller TCON, a source driver SD, and a display panel 130, wherein the source driver SD includes a plurality of driver units 120 and 121. Each driver unit (e.g. the driver unit 120) respectively includes an interface circuit 122, a digital-to-analog converter (DAC) 124, and an output buffer 126. The conventional LCD 100 uses the timing controller TCON to generate various control signals to the source driver SD and the gate driver (not shown) for controlling the source driver SD and the gate driver (not shown) to operate. Under the control of the control signals, the gate driver (not shown) sequentially drives each gate line and then the driver units 120 and 121 in the source driver SD output voltages V136 and V137. The operation detail of each driver unit is known by those skilled in the art, so it is not described here.

The display panel 130 has a plurality of data lines (for example data lines 136 and 137). Each data line is respectively coupled to a plurality of sub-pixel units (here only sub-pixel units 139 and 140 are shown). One group of the sub-pixel units connected by the data line 136 includes a transistor 132 and a liquid crystal capacitor 134. The logic state of the transistor 132 is controlled through the signal of a corresponding scan line 131, and the driver unit 120 can store the charge signal in the capacitor 134. The capacitor 134 stores the data of the data line 136 based on the common voltage Vcom, and the transmittance of the sub-pixel unit is determined by the potential difference of the two ends of the liquid crystal capacitor 134. FIG. 1B is a signal timing diagram illustrating an even data line and an odd data line (here the data line 136 and the data line 137 are used for illustration) in FIG. 1A. The conventional large panel mostly adopts the direct current (DC) common voltage Vcom design, so the data lines 136 and 137 of the display panel 130 have a negative polarity voltage (represented by −) lower than the common voltage Vcom, and a positive polarity voltage (represented by +) higher than the common voltage Vcom. The data line is alternatively driven by the positive polarity voltage and the negative polarity voltage. For example, the voltage swing of the voltage V136 of the data line 136 is SW1A, and the voltage swing of the voltage V137 of the data line 137 is SW1B, as shown in FIG. 1B. The voltage swing width is related to the consumed power magnitude. However, according to the conventional method, the voltage swing at the driver unit 120 is too large and the consumed power is too large, and the temperature of the driver unit 120 is too high.

In order to solve the said problem that the consumed power of the driver unit 120 is too large, FIG. 1C shows a conventional display 150 which includes a charge sharing circuit for reducing the swing of the voltage used to drive the corresponding data line by the driver unit (for example driver units 160 and 170). The display 150 in FIG. 1C includes a timing controller TCON, a source driver SD, and a display panel 180, wherein the source driver SD includes a plurality of driver units (for example the driver unit 160 and the driver unit 170) and switches 172, 174, and 176 (i.e. the charge sharing circuit). Each driver unit (for example the driver unit 160) includes an interface circuit 162, a DAC 164, and an output buffer 166. In the LCD 150, the timing controller TCON generates various control signals to the source driver SD and the gate driver (not shown) for controlling the source driver SD and the gate driver (not shown) to operate. Under the control of the control signals, the gate driver (not shown) sequentially drives each gate line and then the driver units 160 and 170 output voltages V186 and V187.

FIG. 1D is a signal timing diagram of an even data line and an odd data line (here the data line 186 and the data line 187 are used for illustration) in FIG. 1C. In a charge sharing period t1, the switch 172 and the switch 176 are in the OFF state, and the switch 174 is in the ON state, so the charging sharing is generated between the data lines 186 and 187 due to short circuit. Therefore, in the charge sharing period t1, the voltage V186 of the data line 186 and the voltage V187 of the data line 187 converge to approximately the common voltage Vcom, and this is the operation of the charge sharing function. After the charge sharing period t1 is end, the process proceeds to a normal driving period t2, at this time, the switch 172 and the switch 76 are in the ON state, and the switch 174 is in the OFF state, such that the driver units 160 and 170 can drive the data lines 186 and 187. The detail of the driving operation is known by those skilled in the art, so it is not described here.

It is known from FIG. 1D that by the operation of the charge sharing function, in the charge sharing period t1, the voltage level on the data line 186 is drawn to the common voltage Vcom in advance. Therefore, in the normal driving period t2, the swing SW1C of the voltage of the driver unit 160 for driving the data line 186 is reduced. After the normal driving period t2 is end, the process proceeds to a charge sharing period t3, and the internal circuit of the display 150 begins to perform the charge sharing function again, so as to repeatedly perform the same activity. Though the operation of the charge sharing function, the swing of the voltage of the driver unit for driving the data line can be greatly reduced, thereby reducing the power consumption of the driver unit, and achieving the function of power saving.

However, taking column inversion driving method as an example, when a white frame is displayed in the conventional display 150 shown in FIG. 1 C, the voltage V186 of the data line 186 and the voltage V187 of the data line 187 are illustrated as FIG. 1E due to no video data changed. In the meanwhile, if the charge sharing circuit (i.e. the switch 172, 174, 176, and so on) still works during the charge sharing period t1 and t3, there will be an undesired phenomenon similar to toggles shown in FIG. 1F occurring in the voltages V186 and V187. The unexpected situation may cause the operation temperature of the source driver SD to become higher. Therefore, it is desirable to design a proper display apparatus to solve the said problem.

### SUMMARY OF THE INVENTION

Accordingly, the invention is directed to provide a source driver, capable of controlling a charging sharing function thereof in a display to save the power consumption in the source driver and to lower the operation temperature of the source driver.

The invention provides a charging sharing controlling method in the source driver to save the power consumption in the source driver and to lower the operation temperature of the source driver.

In order to solve the problems of the prior art, the invention provides a source driver, which includes a driver unit and a data analysis unit. The driver unit drives a display panel according to a video signal. The data analysis unit, which is coupled to the driver unit, analyzes gray level distribution of the video signal, and the data analysis unit enables or disables a charge sharing function of the driver unit according to an analysis result.

The invention provides a charge sharing controlling method of a source driver. The method includes analyzing gray level distribution of a video signal to obtain an analysis result; and enabling or disabling the charge sharing function of a driver unit in the source driver according to the analysis result.

The source driver and the charge sharing controlling method thereof provided by the invention can control the charge sharing function in the provided source driver, such that the power consumption and the operation temperature of the source driver is both reduced.

In order to make the features and advantages of the invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG 1A shows a conventional LCD.

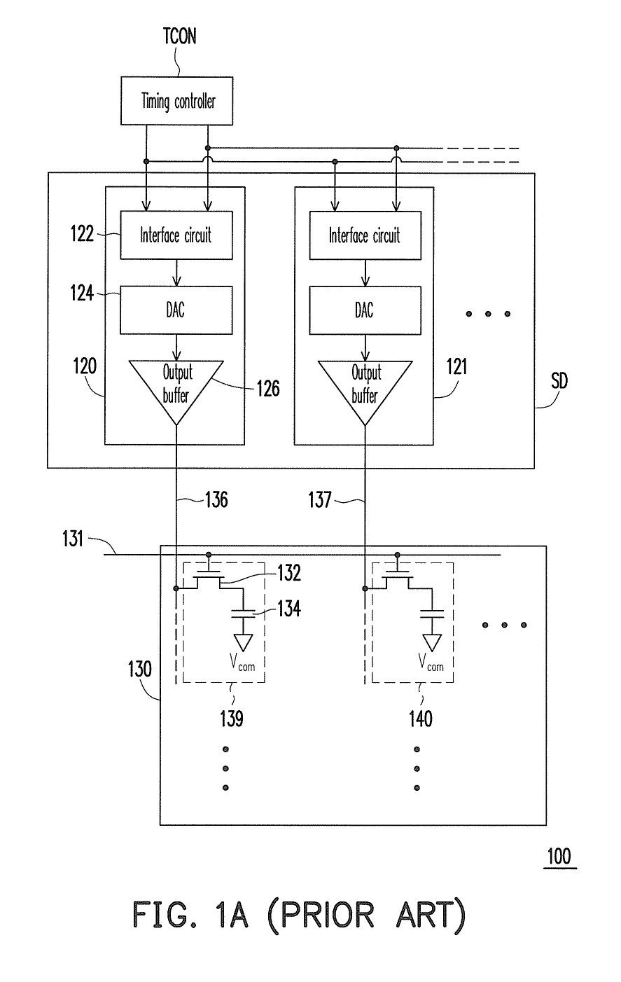

FIG. 1B is a signal timing diagram illustrating an even data line and an odd data line in FIG. 1A.

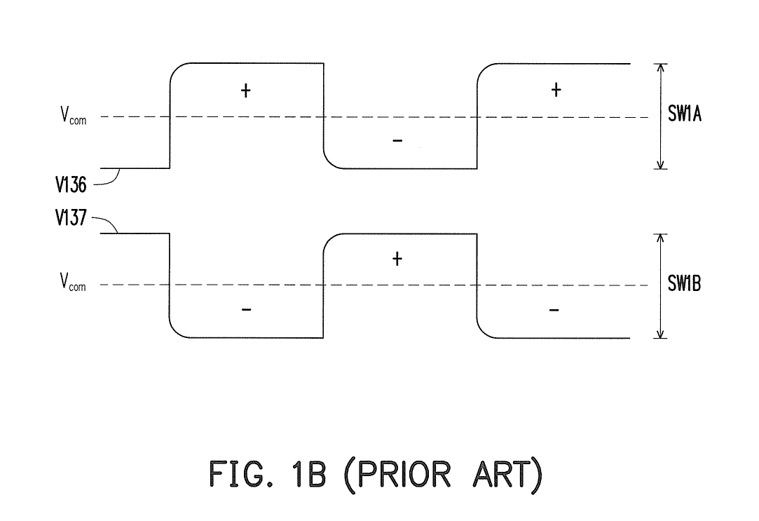

FIG. 1C shows a conventional display.

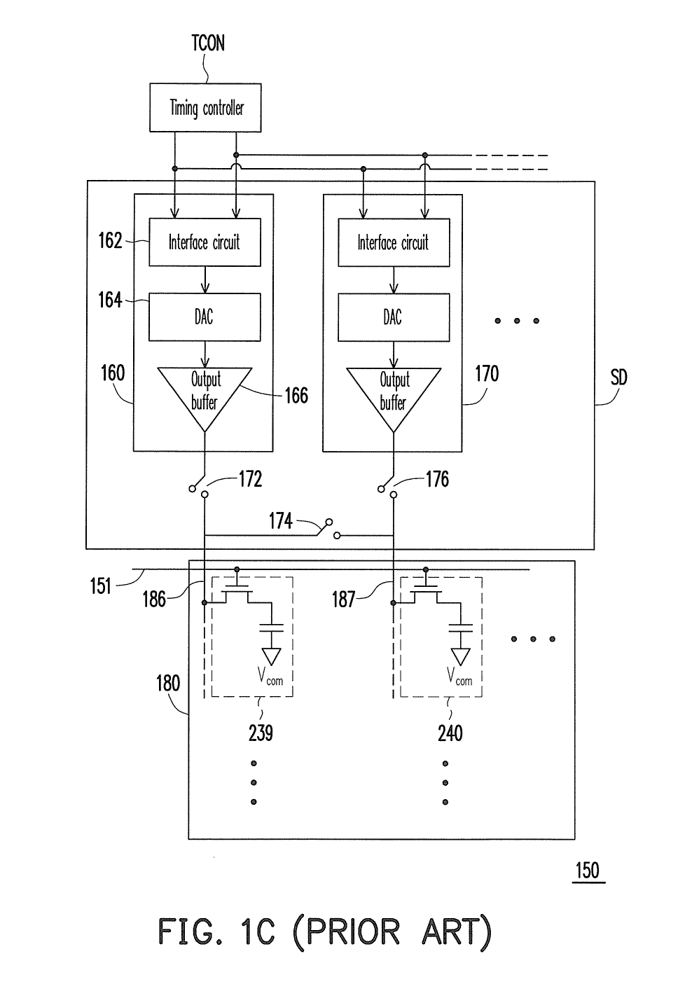

FIG. 1D is a signal timing diagram of an even data line and an odd data line in FIG. 1C.

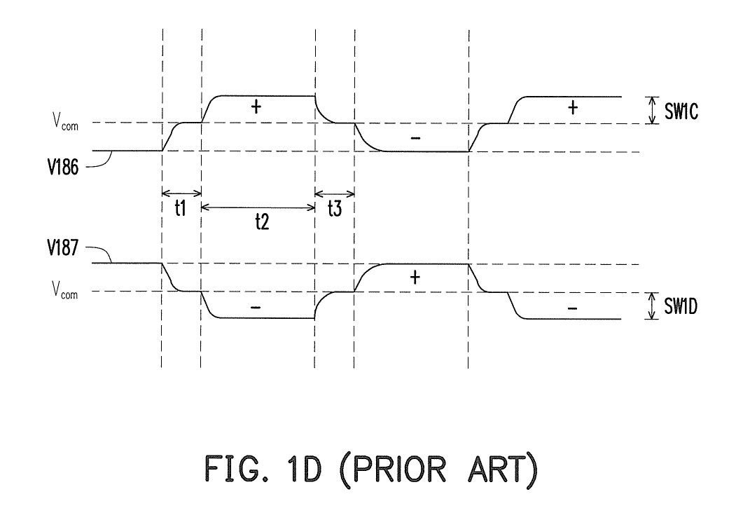

FIG. 1E is a signal timing diagram of an even data line and an odd data line in a while frame without a charge sharing function in FIG. 1C.

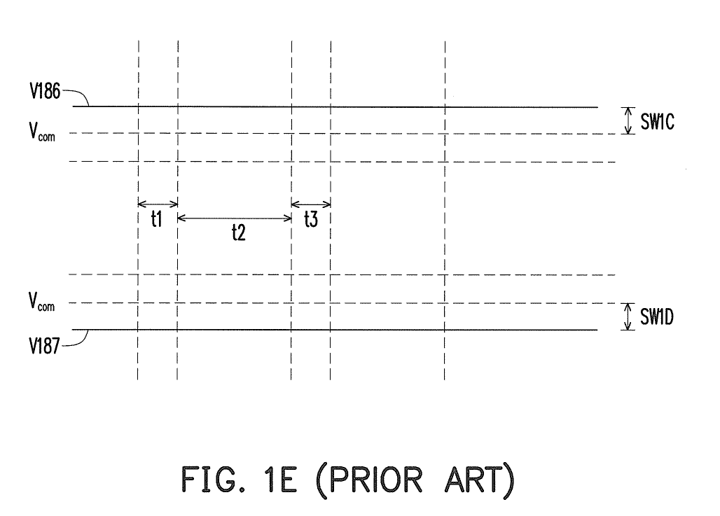

FIG. 1F is a signal timing diagram of an even data line and an odd data line in a while frame with a charge sharing function in FIG. 1C.

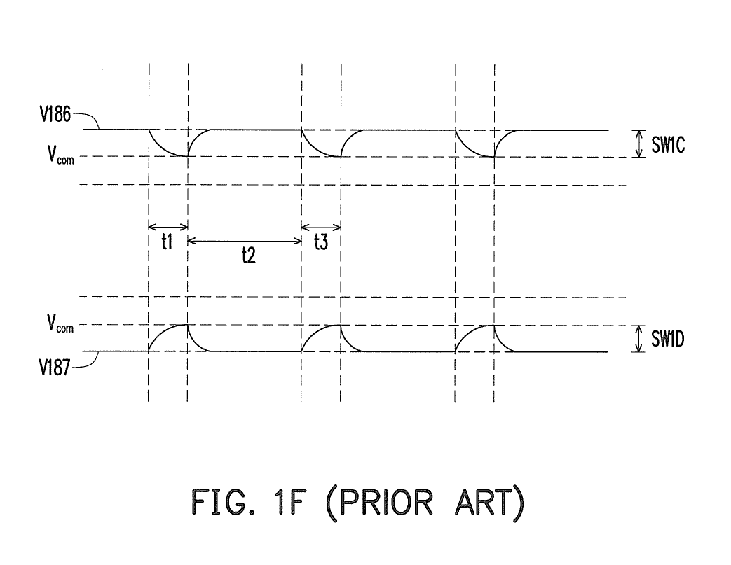

FIG. 2 is a simplified block diagram of a display according to an embodiment of the invention.

FIG. 3 is a simplified block diagram of the driver units and the data analysis unit in the source driver shown in FIG. 2 according to an embodiment of the invention.

FIG. 4 is a simplified block diagram of the data analysis unit shown in FIG. 3 according to an embodiment of the invention.

FIG. 5 is a data transmitting mode of the video data shown in FIG. 3.

FIG. 6 is a simplified block diagram of the driver units and the data analysis unit in the source driver shown in FIG. 2 according to another embodiment of the invention.

### DESCRIPTION OF EMBODIMENTS

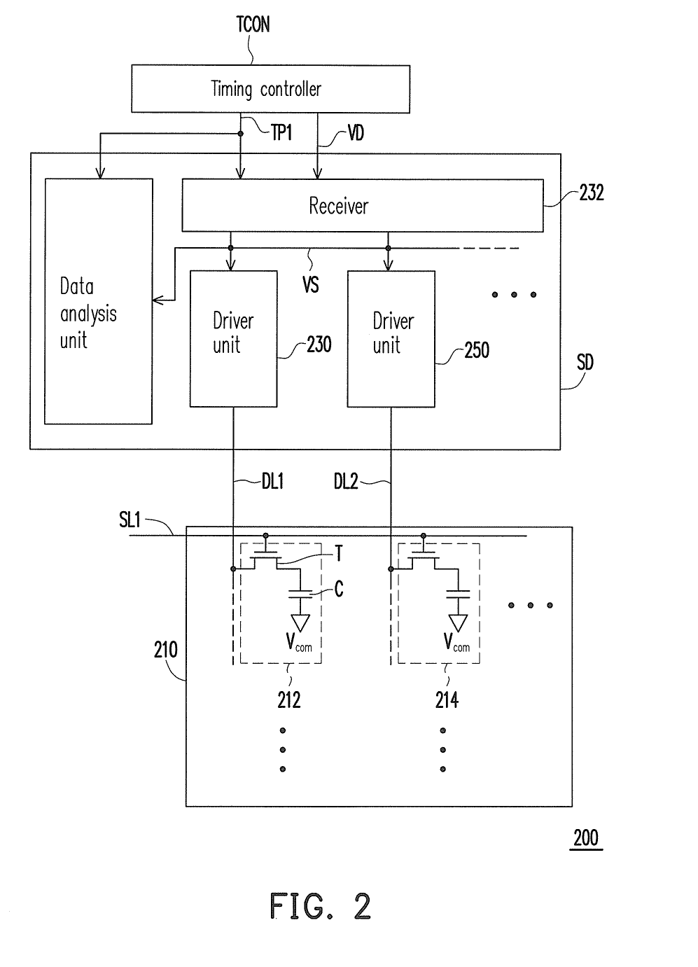

FIG. 2 is a simplified block diagram of a display according to an embodiment of the invention. In the embodiment, the display 200 is a TFT-LCD for example. As shown in FIG. 2, the display 200 includes a timing controller TCON, a source driver SD, and a display panel 210, wherein the source driver SD includes a plurality of driver units (for example driver units 230 and 250), and a receiver and a data analysis unit. The timing controller TCON delivers a horizontal synchronous signal TP1 and a video data VD to each driver unit 230 and 250 through the receiver 232. That is, the receiver 232 receives the video data VD provided by a timing controller TCON, and outputs the corresponding video signal VS to each driver unit 230 and 250. Each driver unit (for example the driver unit 230) drives the display panel 210 according to the video signal. The operation detail of each driver unit is known by those skilled in the art, so it is not further described here.

The display panel 210 has a plurality of data lines (for example data lines DL1 and DL2) and a plurality of scan lines (for example a first scan line SL1). Each data line is respectively coupled to a plurality of sub-pixel units (here only sub-pixel units 212 and 214 are shown). One group of the sub-pixel units 212 connected by the data line DL1 includes a transistor T and a liquid crystal capacitor C. A signal of the corresponding the first scan line SL1 is used to control the transistor T, such that the driver unit 230 stores the data driving voltage in the capacitor C. The capacitor C stores the data of the data line DL1 based on the common voltage Vcom, and the transmittance of the sub-pixel unit 212 is determined by the potential difference between two ends of the liquid crystal capacitor C.

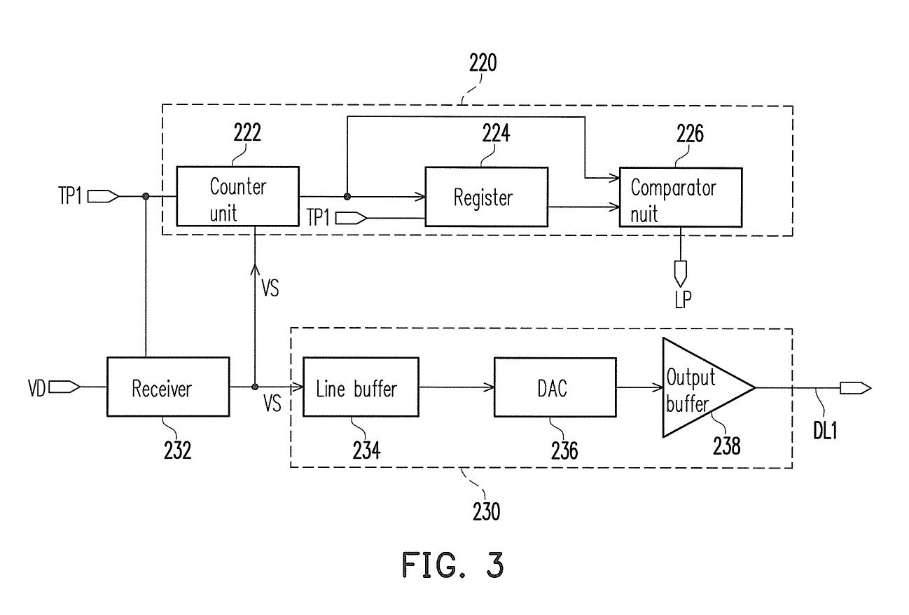

FIG. 3 is a simplified block diagram of the driver units and the data analysis unit in the source driver SD shown in FIG. 2 according to an embodiment of the invention. Herein, only one driver unit 230 and the data analysis unit 220 are shown, but the other driver units in the source driver SD have the same feature as the following. Referring to FIG. 3, the driver unit 230 includes a line buffer 234, a digital-to-analog converter (DAC) 236, and an output buffer 238. The receiver 232 receives the video data VD provided by the timing controller TCON, and then outputs the corresponding video signal VS. The output buffer 238 drives the display panel 200 shown in FIG. 2 to display a corresponding frame. The operation detail of each driver unit is known by those skilled in the art, so it is not further described here.

It should be noted that the data analysis unit 220 is coupled to the output terminal of the receiver 232 for analyzing gray level distribution of the video signal VS, and thus obtaining an analysis result. Then, the data analysis unit 220 outputs a latch pulse signal LP corresponding to the analysis result to enables or disables a charge sharing function of the driver unit 230. Therefore, the charge sharing function is enabled optionally during different charge sharing periods. This embodiment is exemplified by utilizing the TFT-LCD and the latch pulse signal LP for controlling the charge sharing function, but the invention is not limited thereto.

In detail, Referring to FIG. 3, the data analysis unit 220 includes a counter unit 222, a register 224, and a comparator unit 226. In this embodiment, the data analysis unit 220 analyzes a logic state of a most significant bit (MSB) of the video signal VS from the receiver 232 to obtain gray level distribution of the video signal VS. For example, the counter unit counts an amount of the logic state, which is logic 1, of the MSB in the video signal VS, and outputting a counting result, wherein the counter unit 222 resets the counting result according to the horizontal synchronous signal TP1. An input terminal of the register 224 is coupled to an output terminal of the counter unit 222, that is, the register 224 registers the counting result from the counter unit 222 according to a timing of the horizontal synchronous signal TP1, and outputs a previous counting result. Then, the comparator unit 226 is coupled to output terminals of the register 224 and the counter unit 222 for comparing the output results of the register and the counter unit to obtain the analysis result, wherein the output result of the register is X and the output result of the counter unit is Y.

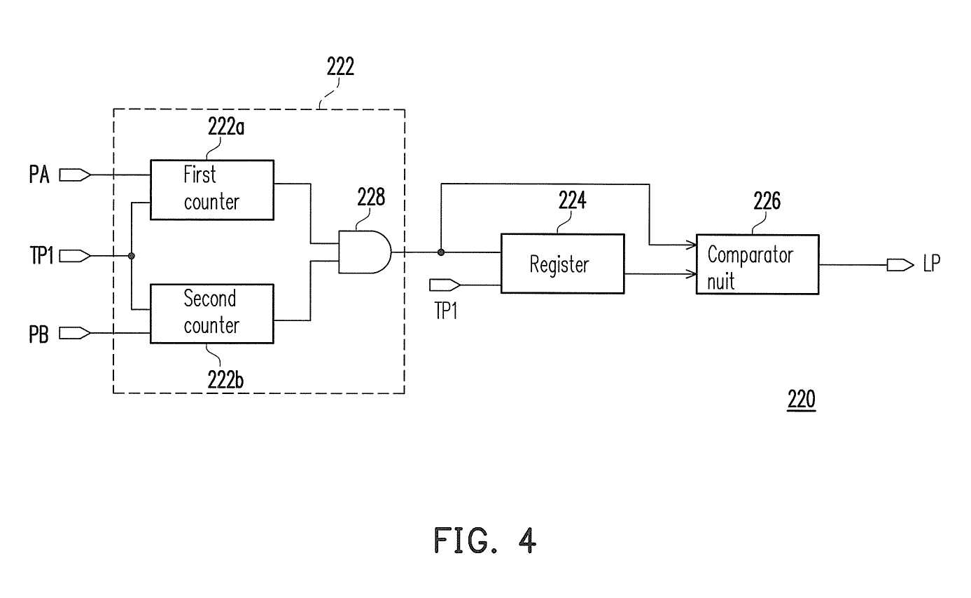

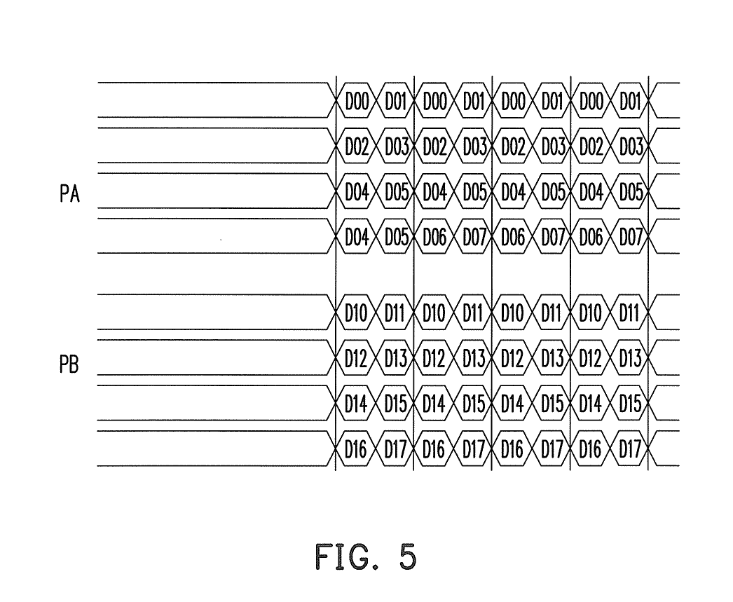

FIG. 4 is a simplified block diagram of the data analysis unit 220 shown in FIG. 3 according to an embodiment of the invention. FIG. 5 is a data transmitting mode of the video data VD shown in FIG. 3. Referring to FIG. 3 through FIG. 5, the video data VD provided by the timing controller TCON is transmitted to the receiver 232 through two data pairs, such as a first data pair PA and a second data pair PB. Herein, the first data pair PA and the second data pair PB are both taken 8-bits as an example shown in FIGS. Then, the receiver 232 outputs the corresponding video signal to the line buffer 234 and the counter unit 222. As a result, a first counter 222a and a second counter 222b in the counter unit 222 receive the first data pair PA and the second data pair PB, respectively. After that, the first counter 222a counts the high MSB, which is denoted as D07 in the first data pair PA for example. While a counting result of the first counter 222a is greater than a threshold gray level value Z, the first counter 222a delivers a high logic level signal to a logic gate 228. In the meanwhile, if a counting result of a second counter 222b related to the second data pair PB is also greater than the threshold gray level value Z, the second counter 222b delivers the high logic level signal to the logic gate 228.

Herein, the logic gate 228 is an AND gate for example, and thus the AND gate outputs the high logic level signal to the register 224 for registering a first logic result X from the AND gate. In other embodiment, the logic gate 228 can also be implemented by an OR gate, but the threshold gray level value Z should be changed correspondingly. After receiving the horizontal synchronous signal TP1, the first logic result X registered in the register 224 is delivered to the comparator unit 226, and the first counter unit 222a, the second counter unit 222b and the register 224 are reset. Then, the counter unit 222 proceeds to count the high MSB of the video signal VS. Similar to the approach for analyzing the video signal VS in the previous timing of the horizontal synchronous signal TP1, a second logic result Y from the AND gate is delivered to the register 224 for registering and to the comparator unit 226 for comparing with the first logic result X.

While the first logic result X is a high logic level and the second logic result Y is a low logic level, it means gray level distribution of the video signal VS in the first scan line SL1, for example, is brighter than in a second scan line SL2 (not shown), and thus the comparator unit 226 outputs a low logic level of the latch pulse signal LP. As a result, the latch pulse signal LP enables the charge sharing function of the driver unit 230. It should be noted that the comparator unit 226 outputs a high logic level of the latch pulse signal LP under other conditions of the first and second logic results X and Y in this embodiment. Therefore, by using the approach mentioned above to analyze the gray level distribution of the video signal VS in any two scan lines of the display panel 210 shown in FIG. 2, the charge sharing function of the driver units in the source driver SD optionally is enabled during different charge sharing periods according to the logic level of the latch pulse signal LP from the data analysis unit 220.

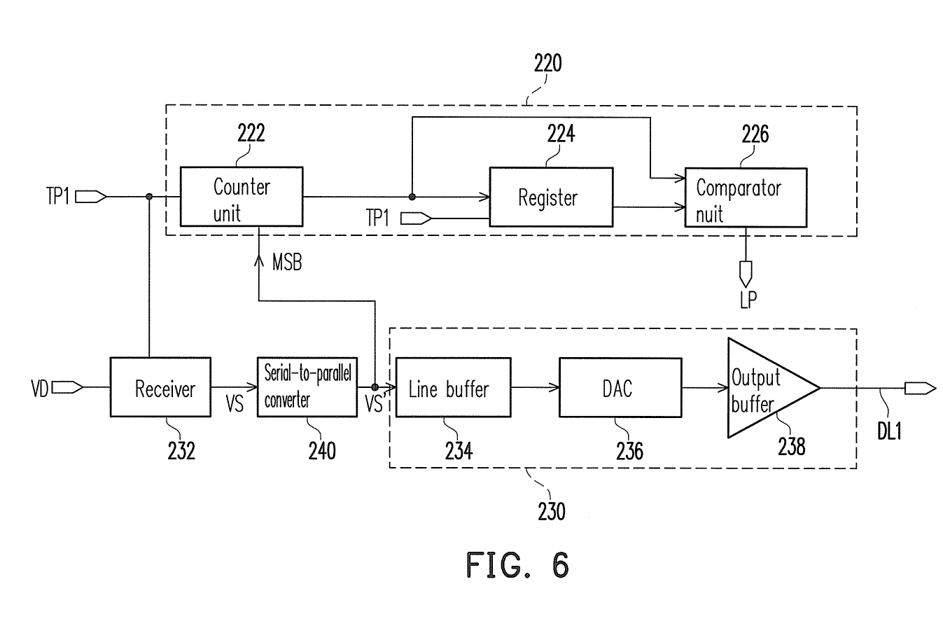

FIG. 6 is a simplified block diagram of the driver units and the data analysis unit in the source driver SD shown in FIG. 2 according to another embodiment of the invention. Herein, only one driver unit 230 and the data analysis unit 220 are shown, but the other driver units in the source driver SD have the same feature as the following. Referring to FIG. 6, the source driver SD further includes a serial-to-parallel converter 240 coupled between the receiver 232 and the driver unit 230 in this embodiment. The serial-to-parallel converter 240 converts the video signal VS from a serial data to a parallel data. In detail, the serial-to-parallel converter 240 receives the video signal VS such as the serial data from the receiver 232, and then converts to the parallel data.

As a result, the serial-to-parallel converter 240 outputs the video signal VS′, which is the parallel data, to the line buffer 234. While the video signal VS′ is transmitted to the line buffer 234, the counter unit 222 in the data analysis unit 220 counts a MSB of the video signal VS′. If a logic level of the MSB is high, which is denoted as “1” for example, the counter unit 222 counts the MSB, and thus a first counting result X is obtained from the counter unit 222. Then, the first counting result X is registered in the register 224. After receiving the horizontal synchronous signal TP1, the first counting result X registered in the register 320 is delivered to the comparator unit 226, and the counter unit 222 and the register 224 are reset. After that, the counter unit 222 proceeds to count the high MSB of the video signal VS′ in the next timing of the horizontal synchronous signal TP1, and delivers to the register 224 for registering a second counting result Y. In the meanwhile, the counter unit 222 also delivers the second counting result Y to the comparator unit 226 for comparing with the first counting result X and a threshold gray level value Z. According to the analysis result, a logic level of a latch pulse signal LP outputted from the comparator unit 226 is decided.

It should be noted that the first counting result X and the second counting result Y compared by the comparator unit 226 represent gray level distribution of the video signal VS′ in the first scan line SL1 and in the second scan line SL2 (not shown), respectively, and the threshold gray level value Z is related to a threshold gray level. For example, if gray levels of the video signal VS′ have levels 0-255, then, the proceeding-50% gray levels are the levels 0-127 (darker regions of an image), while the following-50% gray levels are the levels 128-255 (brighter regions of an image). Consequently, the threshold gray level value Z is the level 127 or 128. Herein, the high MSB mentioned above represents a gray level of the video signal VS′ corresponding to a brighter pixel. That is, if the first counting result X is greater than the threshold gray level value Z (i.e. X>Z), it means gray level distribution of the video signal VS′ in the first scan line SL1 is brighter. In other words, if the second counting result Y is greater than the first counting result X (i.e. Y>X), gray level distribution of the video signal VS′ in the second scan line SL2 is brighter than gray level distribution of the video signal VS′ in the first scan line SL1.

Note that the threshold gray level value Z corresponding to proceeding-50% gray levels and following-50% gray levels of the gray levels 0-255 mentioned in the embodiment are considered as a specific implementation. Anyone skilled in the art would be able to modify the mentioned proceeding-50% gray levels and following-50% gray levels into proceeding-60% gray levels, and following-40% gray levels or proceeding-40% gray levels and following-60% gray levels, etc. Therefore, the invention is not limited to the above-mentioned specific implementation.

Referring to FIG. 6, as known from above, if the analysis result obtain from the data analysis unit 220 is the second counting result Y greater than or equal to the first counting result X (i.e. Y≧X), the logic level of the latch pulse signal LP outputted from the data analysis unit 220 is high, and thus the charge sharing function of the driver units in the source driver SD is disabled during a charge sharing period according to the logic level of the latch pulse signal. Similarly, if the analysis result is Y<X and Y>Z, the logic level of the latch pulse signal LP is high, and the charge sharing function of the driver units in the source driver SD is disabled. In contrast, if the analysis result is Y<X and Y≦Z, the logic level of the latch pulse signal LP is low, and the charge sharing function of the driver units in the source driver SD is enabled according to the logic level of the latch pulse signal LP. Therefore, the charge sharing function of the driver units in the source driver SD optionally is enabled during different charge sharing periods according to the logic level of the latch pulse signal LP from the data analysis unit 220.

The implement of the data analysis unit 220 and the driver units (for example driver units 230 and 250) in the source driver SD for dynamically analyzing gray level distribution of the video signal VS or VS′ may have many varieties, especially the data analysis unit 220. The block design schematically shown in FIG. 2 through FIG. 6 are only illustrated as an example for one skilled in the art to implement the invention, rather than limiting the scope of the invention.

Relatively, in another embodiment of the invention, a method for controlling a charge sharing function in the source driver is provided. The charge sharing controlling method includes: (a) analyzing gray level distribution of a video signal to obtain an analysis result; (b) enabling or disabling the charge sharing function of a deriver unit in the source driver according to the analysis result.

In summary, the source driver in the said embodiment utilizes the data analysis unit for analyzing gray level distribution of the video signal to obtain an analysis result. Then, according to the analysis result, the charge sharing function of the driver units in the source driver optionally is enabled during different charge sharing periods. As a result, the power consumption in the source driver and the operation temperature of the source driver could be reduced as compared with the prior art.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A source driver, comprising:
a driver unit, for driving a display panel according to a video signal; and
a data analysis unit, coupled to the driver unit, the data analysis unit analyzes gray level distribution of the video signal, and enables or disables a charge sharing function of the driver unit according to an analysis result.

2. The source driver as claimed in claim 1, further comprising:
a receiver, for receiving a first video data provided by a timing controller, and outputting the corresponding video signal.

3. The source driver as claimed in claim 2, wherein the driver unit comprises:
a line buffer, an input terminal of the line buffer is coupled to an output terminal of the receiver;
a digital-to-analog converter (DAC), an input terminal of the DAC is coupled to an output terminal of the line buffer; and
an output buffer, an input terminal of the output buffer is coupled to an output terminal of the DAC, and an output terminal of the output buffer for driving the display panel to display a corresponding frame.

4. The source driver as claimed in claim 2, wherein the data analysis unit is coupled to the output terminal of the receiver for analyzing gray level distribution of the video signal.

5. The source driver as claimed in claim 2, further comprising a serial-to-parallel converter, coupled between the receiver and the driver unit.

6. The source driver as claimed in claim 5, wherein the data analysis unit is coupled to the output terminal of the serial-to-parallel converter.

7. The source driver as claimed in claim 1, wherein the data analysis unit analyzes a logic state of a most significant bit (MSB) of the video signal to obtain gray level distribution of the video signal.

8. The source driver as claimed in claim 7, wherein the data analysis unit comprises:
a counter unit, for counting an amount of the logic state of the MSB in the video signal, and outputting a counting result, wherein the counter unit resets the counting result according to a horizontal synchronous signal;
a register, an input terminal of the register is coupled to an output terminal of the counter unit, wherein the register registers the counting result according to a timing of the horizontal synchronous signal, and outputs a previous counting result; and
a comparator unit, coupled to output terminals of the register and the counter unit, for comparing output results of the register and the counter unit to obtain the analysis result.

9. A charge sharing controlling method of a source driver comprising:
analyzing gray level distribution of a video signal to obtain an analysis result; and
enabling or disabling the charge sharing function of a deriver unit in the source driver according to the analysis result.

10. The charge sharing controlling method as claimed in claim 9, wherein analyzing gray level distribution of a video signal comprises:
analyzing a logic state of a MSB of the video signal to obtain gray level distribution of the video signal.

11. The charge sharing controlling method as claimed in claim 10, wherein analyzing gray level distribution of a video signal comprises:
counting an amount of the logic state of the MSB in the video signal for obtaining a counting result;
registering the counting result according to a timing of a horizontal synchronous signal and providing a previous counting result;
comparing the counting result and the previous counting result to obtain the analysis result; and
resetting the counting result according to the timing of the horizontal synchronous signal.
